(19) United States
(12) Patent Application Publication
(10) Pub. No.: US 2002/0103827 A1
(43) Pub. Date: Aug. 1, 2002

(54) System and method for filling out forms

(76) Inventor: Robert Sesek, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/771,132

(22) Filed: Jan. 26, 2001

(51) Int. Cl. G06F 17/24

(52) U.S. Cl. 707/505; 707/507

(57) ABSTRACT

A system and method are provided for filling out forms. The system includes a processor circuit in a server having a processor and a memory. The system also includes a form profile database stored in the memory, the form profile database including a form profile associated with a user, the form profile having a number of data fields. Logic is stored in the memory and executable by the processor to define a form that includes a subset of the number of data fields. Also, logic is stored in the memory and executable by the processor to transmit the form to a client in response to a request from the client. The system may also include logic to verify the identity of a user that requests the form. The system provides several benefits, including that fact that a client can automatically download their personal information for a specific entity without having to fill the same information out in one or more forms. The information downloaded is far less subject to error as it is entered only once and saved in the server.

### TECHNICAL FIELD

The present invention is generally related to the field of form generation and, more particularly, is related to a system and method for filling out forms.

### BACKGROUND OF THE INVENTION

People are constantly providing information about themselves to various entities in connection with the goods and services they receive from those entities. For example, when one visits the doctor's office or the dentist, often one must fill out a lengthy form that asks for one's address, medical history and other pertinent information. Likewise, when one goes to the bank for a loan, one may provide, for example, his or her address and financial information, etc. When subscribing to a magazine or other service, one generally provides address information and other information that is employed in the ongoing relationship with the magazine or service provider.

The fact that the average person provides the same information to several different entities results in a lot of wasted time and effort. Each time one enters into a business relationship or other relationship with a new entity, inevitably one is forced to fill out information on some sort of form for that entity. Since the average person is fallible, it may happen that mistakes occur when providing information to a particular entity.

Also, the information for a particular person is generally subject to change, meaning that a person is obliged to update the information with one or more entities. For example, people often move several times during the course of their life. Upon moving, one must inform various entities of the address change so that they can receive bills or other information at the new address. For example, a magazine will not reach a new address unless the publisher is informed of the change of address. Likewise, creditors who send monthly bills will have to be informed of the change of address or bills will not be received and paid. Due to the inconvenience and inaccuracies that occur when providing personal information to various entities, the act of providing personal information to multiple entities acts as a burden upon individuals in society.

### SUMMARY OF THE INVENTION

In light of the foregoing, the present invention provides for a system and method for filling out forms. In one embodiment, the system includes a processor circuit in a server having a processor and a memory. The system also includes a form profile database stored in the memory, the form profile database including a form profile associated with a user, the form profile having a number of data fields. Logic is stored in the memory and executable by the processor to define a form that includes a subset of the number of data fields. Also, logic is stored in the memory and is executable by the processor to transmit the form to a client in response to a request from the client. The system may also include logic to verify the identity of a user that requests the form.

In another embodiment, the present invention also includes a method for filling out a form. In this regard, the method comprises the steps of: maintaining a database in a server that includes a form profile having a number of data fields, the form profile being associated with a user, defining a form that includes a subset of the data fields in the form profile, and, transmitting the form to a client in response to a request from the client. The present method also includes the step of verifying an identity of the user in the server.

The system and method according to the present invention provide several benefits, including that fact that a client can automatically download their personal information from a central location for a specific entity without having to fill the same information out in one or more forms. The information downloaded is far less subject to error due to the fact that it is entered only once.

Other features and advantages of the present invention will become apparent to a person with ordinary skill in the art in view of the following drawings and detailed description. It is intended that all such additional features and advantages be included herein within the scope of the present invention.

### BRIEF DESCRIPTION OF THE DRAWINGS

The invention can be understood with reference to the following drawings. The components in the drawings are not necessarily to scale. Also, in the drawings, like reference numerals designate corresponding parts throughout the several views.

FIG. 1 is a block diagram of a network that includes a form filling system according to an embodiment of the present invention;

FIG. 2 is a drawing of a graphical user interface outlining various operations that may be performed using the form filling system of FIG. 1;

FIG. 3 is a drawing of a graphical user interface that depicts a form profile with a number of data fields employed in the form filling system of FIG. 1;

FIG. 4 is a drawing of a graphical user interface employed to request a form from the server of FIG. 1;

FIG. 5 is a drawing of a graphical user interface employed to view the entities to whom forms are automatically downloaded upon the occurrence of relevant updates to the respective form profile;

FIG. 6 is a block diagram of a form template employed in the server of FIG.

FIG. 7 is a block diagram of a form generated in the server of FIG. 1;

FIG. 8 is a flow chart of form access logic stored and executed in the server of FIG. 1;

FIG. 9 is a second flow chart further depicting the access logic stored and executed in the server of FIG. 1; and

FIG. 10 is a third flow chart further depicting the access logic stored and executed in the server of FIG. 1.

### DETAILED DESCRIPTION OF THE INVENTION

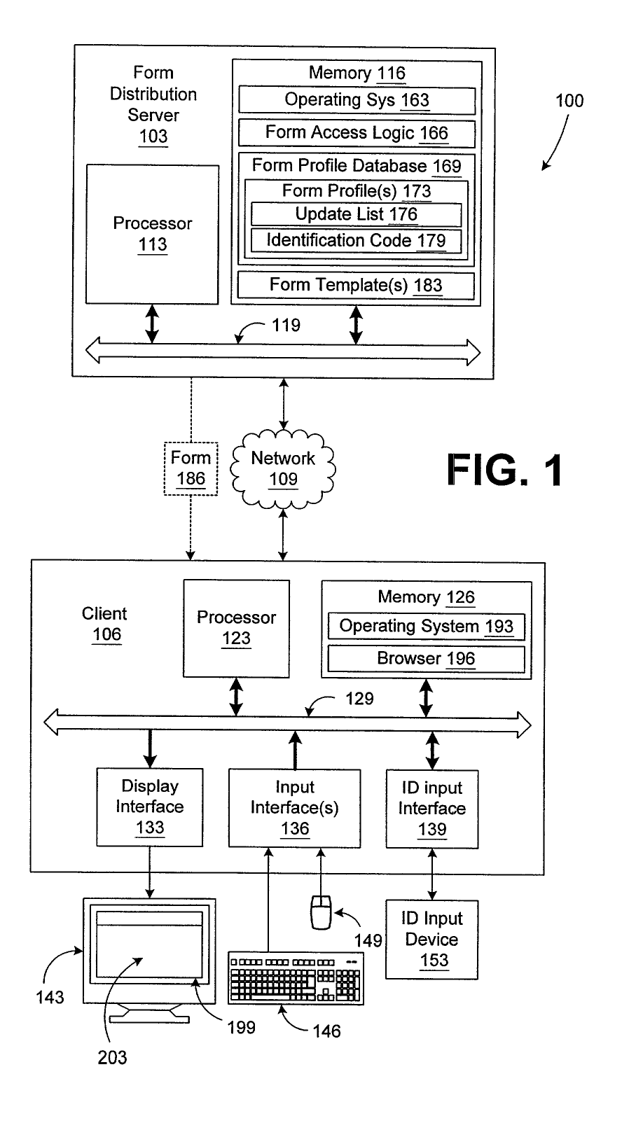

With reference to FIG. 1, shown is a network 100 according to an embodiment of the present invention. The network 100 includes a form distribution server 103 and a client 106. The distribution server 103 and client 106 may be, for example, computer systems or other systems with similar capability. The form distribution server 103 and the client 106 are in data communications with each other via a network 109. The form distribution server 103 includes a processor circuit having a processor 113 and a memory 116, both of which are coupled to a local interface 119. The local interface 119 may be, for example, a data bus with an accompanying control bus as is generally known by those with ordinary skill in the art. The form distribution server 103 may also include, for example, various input and output devices such as display screens, keyboards, mice, printers, scanners, and other such devices.

The client 106 also includes a processor circuit with a processor 123 and a memory 126, both of which are coupled to a local interface 129. The local interface 129 may be, for example, a data bus with an accompanying control bus as is generally known by those with ordinary skill in the art. Also coupled to the local interface 129 is a display interface 133, one or more input interfaces 136, and an identification-input interface 139. The display interface 133 couples a display device 143 to the local interface 129. The display device 143 may be, for example, a cathode ray tube (CRT), a liquid crystal display screen, a gas plasma-based flat panel display, indicator lights, light emitting diodes, or other suitable display device.

The client 106 also may include, for example, a keyboard 146 and a mouse 149 that are linked to the local interface 129 by way of the input interfaces 136 as is generally known by those with ordinary skill in the art. Other user input devices may be employed as well, including, for example, a keypad, touch pad, touch screen, microphone, scanner, mouse, joystick, or one or more push buttons, etc. In addition, user output devices may be coupled to the local interface 129 via appropriate interfaces. Such user output devices may include indicator lights, speakers, printers, etc. The input interfaces 136 may be, for example, various input cards or other such devices as are generally known by those with ordinary skill in the art.

The client 106 also may include an identification input device 153 according to an aspect of the present invention. The identification input device 153 may be, for example, a card reader, a fingerprint reader, a retinal scanner, or other such identification device that harvests a unique identification code associated with an individual that is placed in digital form and supplied to the client 106.

The memories 116 and 126 may include both volatile and nonvolatile memory components. Volatile components are those that do not retain data values upon loss of power. Nonvolatile components are those that retain data upon a loss of power. Thus, the memories 116 and 126 may comprise, for example, random access memory (RAM), read-only memory (ROM), hard disk drives, floppy disks accessed via an associated floppy disk drive, compact disks accessed via a compact disk drive, magnetic tapes accessed via an appropriate tape drive, and/or other memory components, or a combination of any two or more of these memory components.

In addition, the processors 113 and 123 each may represent multiple processors and the memories 116 and 126 each may represent multiple memories that operate in parallel. In such a case, the local interfaces 119 and 129 may be an appropriate network that facilitates communication between any two of the multiple processors or between any processor and any of the memories, etc. The local interfaces 119 and 129 may facilitate memory to memory communication as well. The processors 113/123, memories 116/126, and local interfaces 119/129 may be electrical or optical in nature. Also, the memories 116 and 126 may be magnetic in nature.

The network 109 includes, for example, the Internet, wide area networks (WANs), local area networks (LANs), or other suitable networks, etc., or any combination of two or more such networks. The form distribution server 103 and the client 106 are coupled to the network 109 to facilitate data communication to and from the network 109 in any one of a number of ways that are generally known by those of ordinary skill in the art. For example, the form distribution server 103 and the client 106 may each be individually linked to the network 109 through various devices such as network cards, modems, or other such communications devices. Also, the form distribution server 103 and the client 106 may be coupled to the network 109 through a local area network and an appropriate network gateway or other arrangements, etc. Such networking arrangements are generally understood by those with ordinary skill in the art and, consequently, are not discussed herein in detail.

Stored in the memory 116 in the form distribution server 103 and executable by the processor 113 of the form distribution server 103 is an operating system 163 and form access logic 166. In addition, a form profile database 169 is stored in the memory 116 that includes form profiles 173. Each of the form profiles 173 includes, for example, an update list 176 and an identification code 179. A number of form templates 183 are also stored in the memory 116. The form access logic 166 is executed on the form distribution server 103 to create a form 186 as will be discussed.

Stored in the memory 126 and executable by the processor 123 of the client 106, for example, are an operating system 193 and a browser 196. When the processor 123 executes the browser 196, a browser graphical user interface 199 is displayed on the display device 143 as is generally known by those with ordinary skill in the art. The browser graphical user interface 199 may be employed to view a number of graphical user interfaces 203 that are downloaded from the form distribution server 103 by the client 106 as will be discussed.

Next a general discussion of the operation of the form distribution server 103 and the client 106 is provided. According to the present invention, a user may advantageously store pertinent information about themselves in the form distribution server 103 to be accessed when needed by the user by manipulating any client 106 that is coupled to the network 109. Consequently, a user need not keep such pertinent information on their person at all times. Such information may be, for example, a person's address, telephone number, medical information, financial information, account information (i.e. bank accounts, broker accounts, etc.), and any other such information that a particular user might have to provide to other individuals or entities.

Such information is stored as a form profile 173 in the form profile database 169 of the form distribution server 103. A user may access their particular form profile 173 by manipulating a client 106. Specifically the user may access the form profile 173 by using the browser 196 as is generally known by those with ordinary skill in the art. The form access logic 166 may act, for example, as a web server providing web pages that are accessible by the browser 196 to accomplish the specific tasks that are described herein. By manipulating the browser 196, the user may access their form profile 173 to transmit information or to add and/or change the information that is contained therein.

When the form profile 173 contains the appropriate information, a user may download so called “forms” 186 to various destination addresses on the network 109 to provide the pertinent information in question to various individuals or entities. Specifically, such information may be provided to doctors, publishers (with which one has a subscription), a bank (with which one has an account), or any other individual or entity, etc. A form 186 is defined herein as a subset of all the data fields within the form profile 173. The form 186 may also be the entire form profile 173 if the “subset” includes all of the data fields within the form profile 173. However, it is often the case that the form 186 includes a smaller number of the total data fields in the form profile 173. The form 186 is generated by the form access logic 166 in response to input by the user via the browser 196. A specific example of a user's access to a particular form to be downloaded to a particular individual or entity is provided next in the context of a specific scenario to provide an illustration.

Assume, for example, that John Doe, who maintains a form profile 173 in the form profile database 169, wishes to obtain services from a new doctor. John then visits the new doctor's office and inevitably receives several forms that must be filled out. These forms provide the doctor with John's medical history, for example, to help the doctor treat John for various illnesses. Also, these forms may ask for other pertinent information such as John's home address so that the doctor can bill John for services rendered. John is thus faced with what can be a rather significant task in filling out the various questions asked by the doctor. In all likelihood, John may visit a number of doctors within his lifetime, so it is somewhat inevitable that he will have to fill out the same information for each doctor that he visits, such as the case, for example, if John had to visit specialists in addition to his general physician. Also, John may have to fill out the same information each time he visits the same doctor to ensure that nothing has changed, etc.

Rather than filling out the forms, John may access his form profile 173 in the form profile database 169 through a browser of a client 106 on site at the doctor's office. For example, John may carry a portable device such as a laptop or other such device with which John may access the information himself. By manipulating the browser 196 in the client 106, John can access his form profile 173 pursuant to the form access logic 166. John may request a particular form type to be downloaded that he may provide to the doctor. In this instance, the form type would be a medical form that includes all of his pertinent information such as, for example, his name, address, telephone number, children, spouse, medical information, medical insurance information and other information that is relevant to the doctor.

Note that the form profile database 169 may include, for example, other information such as financial information, etc., that is irrelevant to the doctor and need not be provided. Consequently, John requests only a medical form 186 from the form access logic 166. In response, the form access logic 166 looks up a medical form template 183 that matches the form type requested. The form template 183 that is accessed indicates all of the various data fields in the form profile 173 that should be included within a medical form 186 that is to be downloaded. Based on the fields indicated in the form template 183, the data fields are accessed from John's form profile 173 in the form profile database 169 and included in a form 186 that is stored in the memory 116. Thereafter, the form access logic 166 downloads the newly created form 186 that is a medical form, for example, to the particular client 106 to be provided to John's new doctor. Note that form templates 183 may be created that are specific to a particular doctor or other individual/entity based upon their needs as opposed to generalized form templates 183. Such a specific form template 183 may be created using the client 106 and then downloaded to the form distribution server 103 for future use.

John then can print the form out at the doctor's office or provide the digital embodiment of the form 186 to the doctor's automated patient record system. In this sense, then John is relieved of the obligation of physically filling out the forms necessary for the doctor. This may be particularly useful, for example, if John is sick and perhaps incapable of filling out any forms the doctor necessarily needs. In addition, the form access logic 166 notes the destination address to which the form was sent and stores such destination address in the update list 173 for future updates as will be discussed.

Assume then that John updates his form information, for example, due to moving from one house to another. The form access logic 166 detects any such change in the form profile 173 and automatically transmits updated information to the doctor based on the destination address stored in the update list 176. In this manner, all of the individuals and entities that have received forms 186 in the past continually get updates as they occur. Consequently, John may not need to refill out a form when he makes another visit to his doctor, etc.

In addition, an identification code 179 is associated with the form profile 173. This may be employed to provide security in a manner that verifies that John is the actual user requesting information be downloaded to prevent unauthorized access to John's form profile 173. Specifically, John may enter the identification code 179 into the client 106 that is transmitted to the form distribution server 103. The entered identification code 179 is compared with the identification code 179 stored in the respective form profile 173 to verify a user. Note that the identification code 179 may be entered, for example, using the identification input device 153 at the client 106. Thus, the identification code 179 may be stored on a magnetic card or may be generated from a personal identification number (PIN), fingerprint or other form of biometric identification, or any combination of forgoing, etc.

In addition, a service provider such as John's doctor may be assigned a separate identification code 179 that may be used to download a form 186 given John's permission. The process for the doctor to download John's information is similar to that which John experiences, although access may be limited to downloading a specific type of form 186 or specific fields contained in the particular form profile 173.

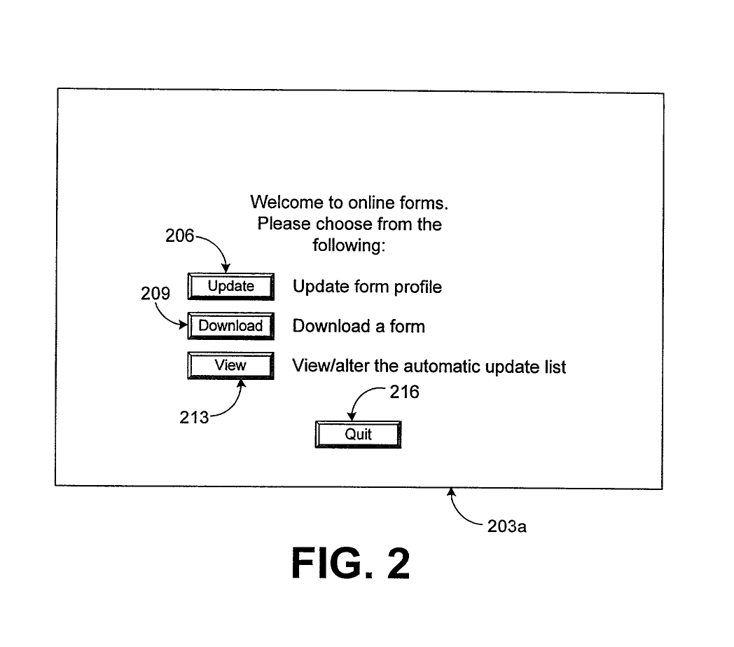

With reference to FIG. 2, shown is a first graphical user interface 203a according to an aspect of the present invention. The first graphical user interface 203a is generated by the form access logic 166 (FIG. 1) when accessed by the browser 196 (FIG. 1). In this regard, the form access logic 166 may comprise, for example, a web server or other server. Before transmitting the first graphical user interface 203a, the form access logic 166 may send other graphical user interfaces that allow the user to identify themselves for security purposes so that the form access logic may verify that the user is in fact the person they claim to be.

Assuming that the user has been verified, once the first graphical user interface 203a has been generated by the form access logic 166, it is transmitted to the client 106 (FIG. 1) and displayed by the browser 196 as is generally known by those with ordinary skill in the art. The user is faced with three choices. First, the user may update their particular form profile 173 (FIG. 1) by manipulating or otherwise pressing the update button 206. Note that to manipulate or press the various buttons as described herein, the user may position a cursor upon the button and click on a mouse or the buttons may be manipulated by some other method as is generally known by those with ordinary skill in the art. The user may manipulate the download button 209 to identify and download a form 186 (FIG. 1) as was discussed previously. Finally, by manipulating the view button 213, the user may view an automatic update list 176 (FIG. 1) that lists the previous form downloads generated by the user for continual updates. The user may choose not to do anything by manipulating the quit button 216 as is generally known by those with ordinary skill in the art. In the case that the user is a service provider who wishes to gain access to a specific form 186 from another individual's form profile 173, the update and view buttons 206 and 209 do not appear based on the identification code 179 (FIG. 1) supplied.

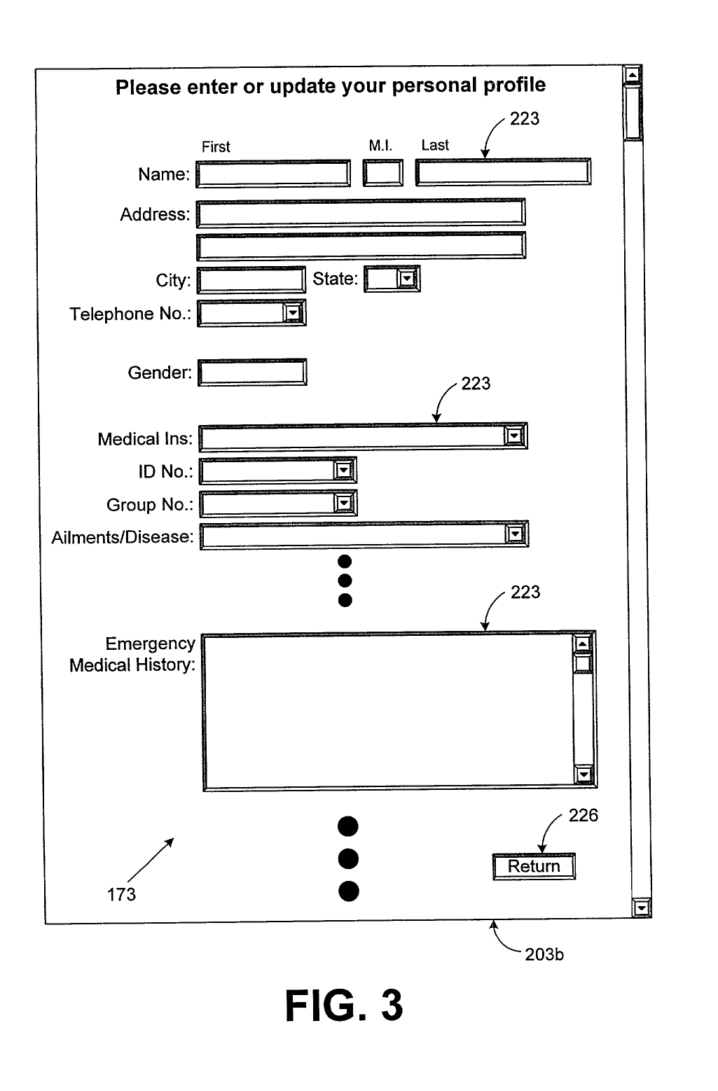

With reference to FIG. 3, shown is a second graphical user interface 103b. Assuming that the user has manipulated the update button 206 (FIG. 2), an appropriate message is transmitted to the form access logic 166 (FIG. 1). In response, the form access logic 166 transmits the second graphical user interface 203b to the client 106 (FIG. 1). In doing so, the form access logic 166 performs a search in the form profile database 169 (FIG. 1) for the form profile 173 associated with the user. The information or data fields contained therein are included within the second graphical user interface 203b. Specifically, the second graphical user interface 203b includes a number of data fields 223 that contain various information. In particular, information such as an individual's name, address, city, state, telephone number, zip code, gender, medical insurance information, medical history information, financial information, and/or any other information that a user may want to impart to third parties or entities for various reasons.

By manipulating the second graphical user interface 203b, the user may change any of the entries within the various data fields if such changes are necessary, or add further information if such information is to be added. Also, a user may delete any current information if necessary. When the user has completed making appropriate changes to the form profile 173, the user may manipulate the return button 226 to send the form profile back to the form distribution server 103 (FIG. 1). In response, the form access logic 166 stores the updated or new form profile 173 in the form profile database 169 (FIG. 1).

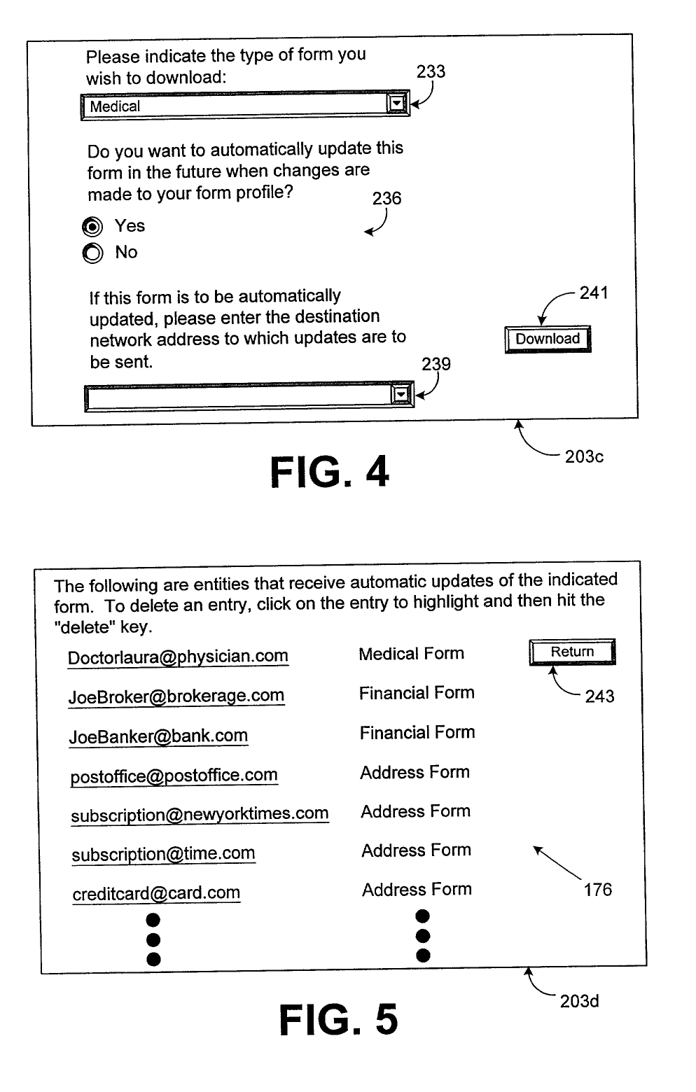

With reference to FIG. 4, shown is a third graphical user interface 203c according to another aspect of the present invention. Assuming that the user has manipulated the download button 209 (FIG. 2), an appropriate message is transmitted to the form distribution server 103 (FIG. 1). In response, the form access logic 166 (FIG. 1) transmits the third graphical user interface 203c to the client 106 (FIG. 1) for display by the browser 196 (FIG. 1). The third graphical user interface 203c includes a form type field 233, an automatic update indication 236, and a destination address field 239. The form type field 233 may include a pull down list of the various types of forms 186 (FIG. 1) that a user may download to a particular location. The automatic update indication 236 indicates whether a current download of a particular form 186 is to be updated with future downloads if information within the form 186 has changed.

The destination address field 239 indicates the particular uniform resource locator (URL) or other destination address on the network 109 (FIG. 1) to which the updates are to be transmitted in the future. The auto update indication 236 includes yes and no toggle indicators, for example, although other types of indicators may be employed as is generally known by those with ordinary skill in the art. To download a form, a user identifies the form type in the form type field 233 and the destination address on the network 109 in the destination address field 239. Both the form type field 233 and the destination address field 239 may include a pull down list as well as the ability to “browse” for the desired information, etc. Also, the user may choose a state for the auto update indication 236 to indicate whether the downloaded form 186 should be automatically downloaded when updates occur in the future. Finally, the user may manipulate the download button 241 to transmit the form type, auto update indication, and the destination address to the server 103 so that an appropriate download of the identified form 186 may be executed. Note that the auto update indication 236 and the destination address field 239 would not appear in the third graphical user interface 203c in the case that an authorized service provider (such as John's doctor) is requesting a download of a particular form 186.

Turning to FIG. 5, shown is a fourth graphical user interface 203d that is transmitted to the client 106 (FIG. 1) by the form access logic 166 (FIG. 1) in response to a message received when the user manipulates the view button 213 (FIG. 2). The fourth graphical user interface 203d includes the update list 176 that is associated with the particular user. As shown, the update list 176 includes destination addresses and form types for the particular forms 186 (FIG. 1) that are to be downloaded upon an occurrence of a change in the form profile 173 (FIG. 1) that affects the respective forms 186. A user may desire to delete one of the entries in the update list 176 due to the termination of a relationship with that individual or entity. By manipulating the return button 243, the user transmits the revised update list 176 to the form distribution server 103 to be included in the form profile 173.

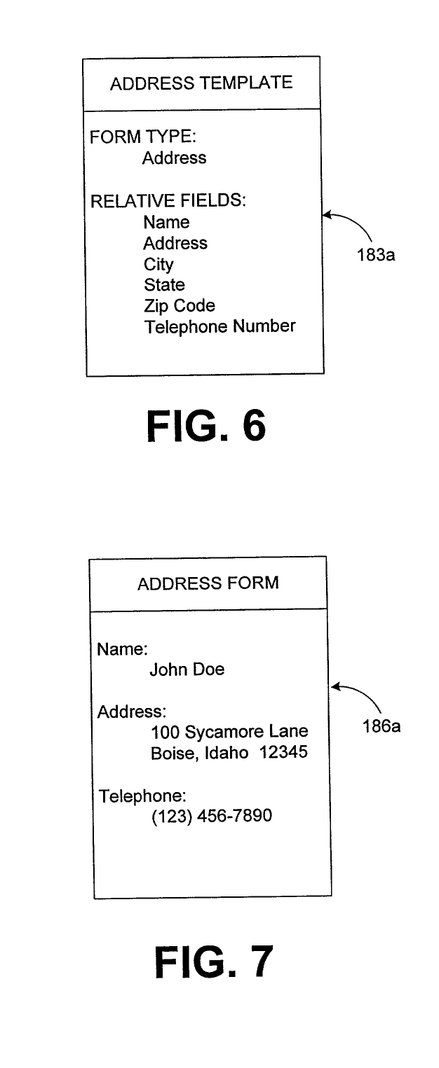

With reference to FIG. 6, shown is an address template 183a according to another aspect of the present invention. The address template 183a is one of the form templates 183 (FIG. 1) stored in the memory 116 (FIG. 1) of the form distribution server 103 (FIG. 1). As shown, the address template 183a includes a form type indication (“ADDRESS FORM”). Also, the address template 183a includes a list of data fields that comprise the subset of data fields that are included in a form 186 (FIG. 1) based on the address template 183a. The address template 183a provides an illustration of the substantive information contained in the form templates 183. The address template 183a also provides an example of the multitude of different types of form templates 183 that may be accessed by the form access logic 166 (FIG. 1) to determine the particular fields from the form profile 173 (FIG. 1) that are to be included in a specific form 186 requested by a user. Also, a unique address template may be created for specific individuals or entities that need a unique combination of information from a given form profile 173.

With reference to FIG. 7, shown is an address form 186a according to an aspect of the present invention. The address form 186a includes a user's name, address, and telephone number that may be supplied to various individuals or entities such as, for example, a publisher with whom a user may have a subscription for a magazine, etc. Note that the data fields contained within the address form 186a are a subset of the total data fields contained within the form profile 173 (FIG. 1).

The forms 186 (FIG. 1) and the templates 183 (FIG. 1) may be implemented, for example, in terms of an extensible markup language (XML) file or other such data file as generally known by those with ordinary skill in the art. The data fields contained within the forms 186 may be accessed digitally by recognizing various tags, etc., within the form 186 and the information contained therein may be automatically integrated into a separate system, etc.

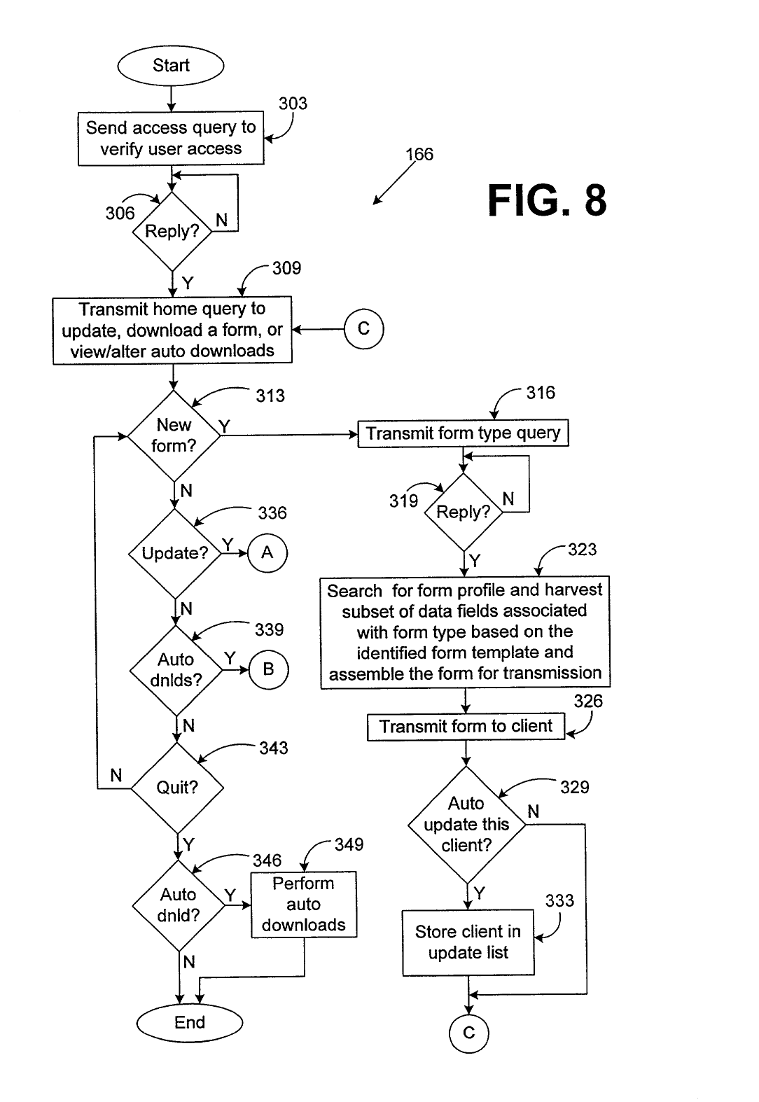

With reference to FIG. 8, shown is a flow chart of the form access logic 166 according to an aspect of the present invention. The form access logic 166 is executed in the processor 113 (FIG. 1) to perform the various functions of generating the graphical user interfaces 203 (FIG. 1) as well as to generate the various forms 186 (FIG. 1) and perform other functions as described previously. The form access logic 166 may be implemented, for example, as a web server or other suitable configuration. Beginning with block 303, the form access logic 166 transmits an access query to the user at the client 106 (FIG. 1) to verify the that the user has access to a particular form profile 173 (FIG. 1). The query transmitted is in the form, for example, of a web page that allows the user to enter verification or identification information. Such information may be input at the client 106, for example, by using the identification input device 153 (FIG. 1).

Thereafter, the form access logic 166 moves to block 306 in which it waits for a reply to verify the user is whom the user claims to be. Then, in block 309, assuming that a response has been received verifying the user, the form access logic 166 transmits the first graphical user interface 203a (FIG. 2) to allow the user to choose between updating the form profile 173, downloading a form 186, or viewing/altering the update list 176. Thereafter, in block 313 the form access logic 166 determines whether the user has manipulated the download button 209 (FIG. 2) indicating that they wish to download a new form 186 (FIG. 1). If such is the case then the form access logic 166 moves to block 316 in which the third graphical user interface 203c (FIG. 4) is transmitted to the client 106 to be viewed via the browser 196 (FIG. 1). Thereafter, the form access logic 166 waits for a reply in block 319. Assuming that a reply is received, the form access logic 166 moves to block 323. The reply that is received indicates the form type of the form 186 that is being requested.

In block 323 the form access logic 166 searches the form profile database 169 (FIG. 1) for the particular form profile 173 that is associated with the current user identified during the verification in block 303. Also, the appropriate form template 183 (FIG. 1) is identified so that the various data fields to be harvested from the form profile 173 are known. The form access logic 166 then assembles the form 186 for transmission to the client 106. Thereafter, the form access logic 166 progresses to block 326 in which the form 186 is transmitted to the client 106.

Then, in block 329, the form access logic 166 determines whether the form 186 transmitted is to be updated in the future in lieu of subsequent changes to the form profile 173. This may determined based upon the information received from the user when the user manipulates the automatic update indication 236 and enters an address in the destination address field 239 of the third graphical user interface 203c as described previously with reference to FIG. 4. If the form is to be updated in the future, then the form access logic 166 moves to block 333 in which the destination address and form type are stored in the update list 176 (FIG. 1). Thereafter, the form access logic moves through connector C to block 309. If there is to be no future updates of the form 186 downloaded in block 329, then the form access logic 166 proceeds through connector C to block 309.

Referring back to block 313, if the user does not indicate that a form 186 is to be created and downloaded, then the form access logic moves to block 336 in which the form access logic 166 determines whether the user has manipulated the 10 update button 206 (FIG. 2) in order to update the form profile 173. If such is the case, then the form access logic 166 moves to connector A as shown. Otherwise the form access logic 166 moves to block 339. In block 339, the form access logic 166 determines whether the view button 213 (FIG. 2) has been manipulated so that the user may view the update list 176 accordingly. If such is the case, then the form access logic 166 moves to connector B as shown. Otherwise, the form access logic 166 moves to block 343.

In block 343 the form access logic 166 determines whether the user desires to quit with their current action by manipulating the quit button 216 (FIG. 2). If such is the case then the form access logic moves to block 346. Otherwise the form access logic 166 reverts back to block 313. In block 346 it is determined whether there should be any automatic downloads of forms 186 due to any potential changes that have been made to the form profile 173 with respect to block 336, etc. If such is the case then the form access logic 166 moves to block 349 in which the form types noted in the update list 176 (FIG. 1) are identified to determine whether any changes have occurred to the data fields included therein. If such is the case, then the specific forms 186 are downloaded to the respective destination addresses noted in the update list 176 so that the recipients are provided with updated information. Thereafter, the form access logic 166 ends accordingly. If in block 346 there is to be no automatic download due to the fact that no data in the form profile 173 has changed, then the form access logic 166 ends as shown.

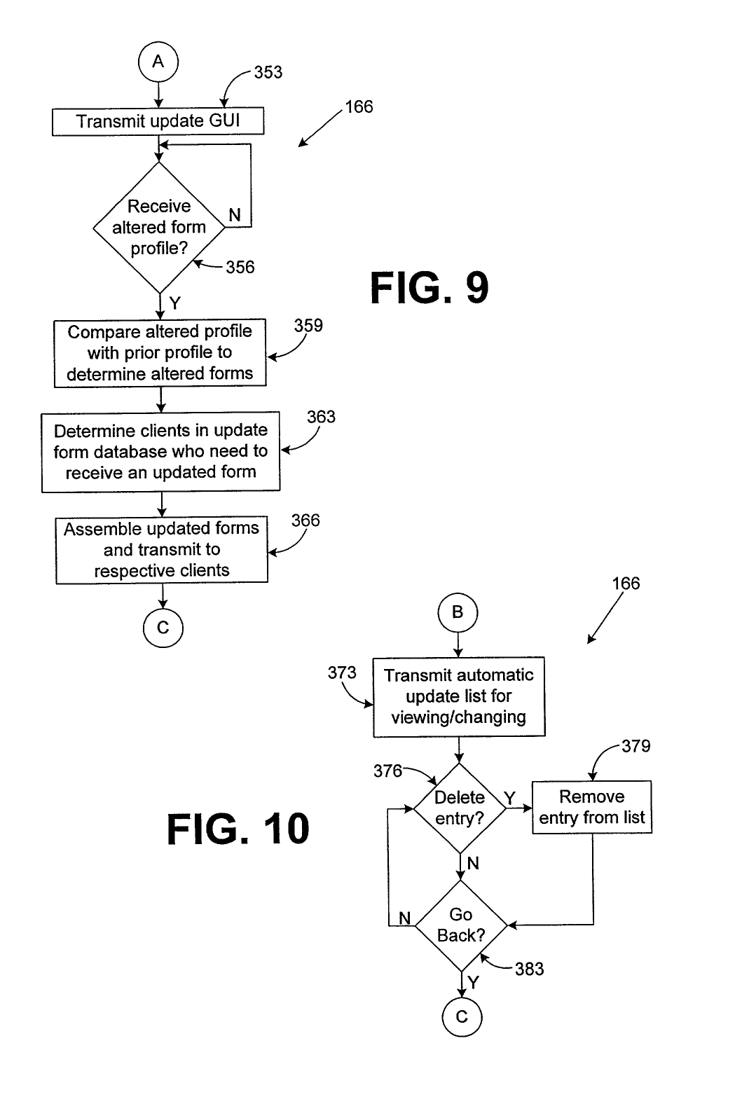

With reference to FIG. 9, shown is a flow chart that further illustrates the form access logic 166. Beginning at connector A, the form access logic 166 moves to block 353 after having received an indication from the client 106 (FIG. 1) that the user wishes to update the form profile 173 (FIG. 1). At block 353, the second graphical user interface 203b (FIG. 3) is transmitted to the client 106 to be viewed by the browser 196 (FIG. 1). The user may then make alterations or add information to the form profile 173 through the second graphical user interface 203b as discussed previously. In block 356, the form access logic 166 determines whether the altered form profile 173 has been received from the client 106 after having been updated by the user.

Assuming such to be the case, the form access logic 166 moves to block 359 in which the altered form profile 173 received from the client 106 is compared with the prior stored form profile 173 to determine which data fields contained therein have been altered. The form access logic 166 then determines which form types are implicated by the alterations made to the various data fields. In this manner, the particular forms 186 that require updating are determined. The form access logic 166 then moves to block 363 to determine the destination addresses in the update list 176 (FIG. 1) to which any altered forms 186 (FIG. 1) are to be transmitted. Thereafter, in block 366 the updated forms 186 to be transmitted are assembled and transmitted to the respective clients 106 based upon the destination addresses identified. The form access logic 166 then moves to connector C.

With reference to FIG. 10, shown is a flow chart that further illustrates the form access logic 166. The form access logic 166 begins with connector B in which it has already been determined that the user wishes to view and/or add/change the individuals or entities to which an automatic download is transmitted. Beginning with block 373, the automatic update list 176 (FIG. 1) is transmitted to the client 106 (FIG. 1) for viewing by the browser 196 (FIG. 1) in the form of the fourth graphical user interface 203d (FIG. 5). Thereafter in block 376, the form access logic 166 determines whether the user has deleted an entry in the update list 176 based upon an appropriate message received from the client 106. If such is the case then the form access logic 166 moves to block 379 in which the particular entry is removed from the update list 176 and the profile 173 (FIG. 1). Thereafter, the form access logic 166 moves to block 383.

Assuming that there is no entry deleted then the form access logic 166 moves to block 383. In block 383, the form access logic 166 determines whether the user wishes to go back to the first graphical user interface 203a (FIG. 2) as indicated by a message received when the user manipulates the Return button 243 (FIG. 5). If such is the case then the form access logic 166 moves to connector C. Otherwise, the form access logic 166 reverts back to block 376. Thus the form access logic 166 simply waits after it has transmitted the fourth graphical user interface 203d to the client to receive appropriate action based upon the input of the user.

Referring back to FIGS. 8-10, although the form access logic 166 of the present invention are embodied in software executed by general purpose hardware as discussed above, as an alternative the same may also be embodied in dedicated hardware or a combination of software/general purpose hardware and dedicated hardware. If embodied in dedicated hardware, the form access logic 166 can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, programmable gate arrays (PGA), field programmable gate arrays (FPGA), or other components, etc. Such technologies are generally well known by those skilled in the art and, consequently, are not described in detail herein.

The flow charts of FIGS. 8-10 show the architecture, functionality, and operation of an implementation of the form access logic 166. If embodied in software, each block may represent a module, segment, or portion of code that comprises one or more executable instructions to implement the specified logical function(s). If embodied in hardware, each block may represent a circuit or a number of interconnected circuits to implement the specified logical function(s). Although the flow charts of FIGS. 8-10 show a specific order of execution, it is understood that the order of execution may differ from that which is depicted. For example, the order of execution of two or more blocks may be scrambled relative to the order shown. Also, two or more blocks shown in succession in FIGS. 8-10 may be executed concurrently or with partial concurrence. It is understood that all such variations are within the scope of the present invention. Also, the flow charts of FIGS. 8-10 are relatively self-explanatory and are understood by those with ordinary skill in the art to the extent that software and/or hardware can be created by one with ordinary skill in the art to carry out the various logical functions as described herein.

Also, the form access logic 166 can be embodied in any computer-readable medium for use by or in connection with an instruction execution system such as a computer/processor based system or other system that can fetch or obtain the logic from the computer-readable medium and execute the instructions contained therein. In the context of this document, a “computer-readable medium” can be any medium that can contain, store, or maintain the form access logic 166 for use by or in connection with the instruction execution system. The computer readable medium can comprise any one of many physical media such as, for example, electronic, magnetic, optical, electromagnetic, infrared, or semiconductor media. More specific examples of a suitable computer-readable medium would include, but are not limited to, a portable magnetic computer diskette such as floppy diskettes or hard drives, a random access memory (RAM), a read-only memory (ROM), an erasable programmable read-only memory, or a portable compact disc.

Although the invention is shown and described with respect to certain preferred embodiments, it is obvious that equivalents and modifications will occur to others skilled in the art upon the reading and understanding of the specification. The present invention includes all such equivalents and modifications, and is limited only by the scope of the claims.

What is claimed is:

1. A method for filling out a form, comprising the steps of:
maintaining a database in a server that includes a form profile having a number of data fields, the form profile being associated with a user;
maintaining a form template in the server, the form template including a list that comprises a subset of data fields in the form profile;
defining a form that includes a data entry from each of the data fields in the form profile that are included in the list in the template; and
transmitting the form to a client in response to a request from the client.

2. The method of claim 1, further comprising the step of verifying an identity of the user in the server.

3. The method of claim 1, further comprising the step of updating the form profile based upon an input by the user received from the client.

4. The method of claim 2, wherein the step of verifying an identity of the user in the server further comprises the steps of:
transmitting a request for an identification code to the client; and
verifying an identification code received from the client.

5. The method of claim 3, further comprising the steps of:
identifying a form subject to an update due to the updating of the form profile; and
transmitting an updated form to the client, wherein the client previously received the form.

6. The method of claim 5, further comprising the step of maintaining a list in the server of a number of clients to receive one of a number of updated forms.

7. A system for filling out a form, comprising:
a processor circuit in a server having a processor and a memory;
a form profile database stored in the memory, the form profile database including a form profile associated with a user, the form profile having a number of data fields;
a form template stored in the memory, the form template including a list that comprises a subset of data fields in the form profile;
logic stored in the memory and executable by the processor to define a form that includes a data entry in each of the data fields included in the list in the form template; and
logic stored in the memory and executable by the processor to transmit the form to a client in response to a request from the client.

8. The system of claim 7, further comprising logic stored in the memory and executable by the processor to verify an identity of the user.

9. The system of claim 8, wherein the logic stored in the memory and executable by the processor to verify an identity of the user further comprises:
logic stored in the memory and executable by the processor to transmit a request for an identification code to the client; and
logic stored in the memory and executable by the processor to verify an identification code received from the client.

10. The system of claim 9, wherein the logic stored in the memory and executable by the processor to verify an identification code received from the client further comprises logic stored in the memory and executable by the processor to compare the identification code with a predefined identification code stored in the memory to determine an existence of a match there between.

11. The system of claim 10, wherein the identification code and the predefined identification code further comprise a biometric identification code.

12. The system of claim 7, further comprising logic stored in the memory and executable by the processor to update the form profile by altering a data entry within one of the data fields based upon an input by the user.

13. The system of claim 12, further comprising:
logic stored in the memory and executable by the processor to identify an update in the form due to the updating of the form profile; and
logic stored in the memory and executable by the processor to transmit the form with the update to the client, wherein the client previously received the form without the update.

14. The system of claim 13, further comprising a list included in the form profile database, the list comprising at least one client that is to receive the form with the update.

15. A system for filling out a form, comprising:
a form profile database stored in a memory, the form profile database including a form profile associated with a user, the form profile having a number of data fields;
means for defining a subset of the data fields in the form profile;
means for defining a form that includes the subset of the data fields in the form profile; and
means for transmitting the form to a client in response to a request from the client.

16. The system of claim 15, further comprising verification means for verifying an identity of the user.

17. The system of claim 16, wherein the verification means further comprises:
means for transmitting a request for an identification code to the client; and
means for verifying an identification code received from the client.

18. The system of claim 17, wherein the means for verifying an identification code received from the client further comprises means for comparing the identification code with a predefined identification code to determine an existence of a match therebetween.

19. The system of claim 18, wherein the identification code and the predefined identification code further comprise a biometrics identification code.

20. The system of claim 15, further comprising means for updating the form profile by altering a data entry within one of the data fields based upon an input by the user.
